(19) United States
(12) Patent Application Publication
(10) Pub. No.: US 2014/0351239 A1
(43) Pub. Date: Nov. 27, 2014

(54) HARDWARE ACCELERATION FOR QUERY OPERATORS

(71) Applicant: Microsoft Corporation, Redmond, WA (US)

(72) Inventors: John D. Davis, San Francisco, CA (US); Eric S. Chung, Sunnyvale, CA (US)

(73) Assignee: Microsoft Corporation, Redmond, WA (US)

(21) Appl. No.: 13/900,537

(22) Filed: May 23, 2013

(51) Int. Cl. G06F 17/30

(52) U.S. Cl. CPC G06F 17/30483
USPC 707/718

(57) ABSTRACT

A hardware device is used to accelerate query operators including Where, Select, SelectMany, Aggregate, Join, GroupBy and GroupByAggregate. A program that includes query operators is processed to create a query plan. A hardware template associated with the query operators in the query plan is used to configure the hardware device to implement each query operator. The hardware device can be configured to operate in one or more of a partition mode, hash table mode, filter and map mode, and aggregate mode according to the hardware template. During the various modes, configurable cores are used to implement aspects of the query operators including user-defined lambda functions. The memory structures in the hardware device are also configurable and used to implement aspects of the query operators. The hardware device can be implemented using a Field Programmable Gate Array or an Application Specific Integrated Circuit.

### BACKGROUND

Query languages stand at the forefront of information retrieval, analytics, and database management systems. The Structured Query Language (“SQL”) is a well-known example of a domain-specific query language used for managing relational databases. Another example, Language Integrated Queries (“LINQ”), provides native querying capabilities in existing managed languages, enabling broad classes of applications such as machine learning or large-scale data mining. Unlike general-purpose programming languages, query languages expose a convenient set of declarative interfaces and operators (such as Select, Where, Aggregate, Join, GroupBy, etc.) that perform transformations on large data collections.

In applications with high performance computing or energy efficiency requirements, hardware-accelerated query processing has become an attractive approach for achieving orders-of-magnitude improvements in both performance and energy efficiency relative to general-purpose processors. Past approaches to hardware-based acceleration of query processing have focused primarily on simple operators such as restrictions (i.e., Where), projections (i.e., Select), and aggregations (i.e., Aggregate). However, the more complex operators such as GroupBy and Join are left to the processor due to their irregular memory access characteristics.

### SUMMARY

A hardware device is used to accelerate query operators including Where, Select, SelectMany, Aggregate, Join, GroupBy and GroupByAggregate. A program that includes query operators is processed to create a query plan. A hardware template associated with the query operators in the query plan is used to configure the hardware device to implement each query operator. The hardware device can be configured to operate in one or more of a partition mode, hash table mode, filter and map mode, and aggregate mode according to the hardware template. During the partition, hash table, filter and map, and aggregate modes, configurable cores are used to implement aspects of the query operators including user-defined lambda functions. The hardware device can be implemented using a Field Programmable Gate Array or, because of a configurable hardware template, as an Application Specific Integrated Circuit.

In an implementation, a query plan is received at a computing device. The query plan comprises a plurality of computational nodes, and each computational node corresponds to a query operator. A mapping of the query operators corresponding to one or more of the computational nodes to one or more components of a hardware device is generated. One or more of the query operators are caused to be executed at the hardware device according to the mapping by the computing device.

In an implementation, a hardware template corresponding to a query operator is received at a hardware device. Data associated with the query operator is received at the hardware device. In partition mode, the received data is processed and stored in a plurality of partitions according to the hardware template by the hardware device. In hash table mode, the data in the plurality of partitions is processed according to the hardware template by the hardware device. In filter and map mode, the received data is filtered and processed or projected according to the hardware template by the hardware device. In aggregate mode, the data is processed and stored in registers processed according to the hardware template by the hardware device. The processed stored data is provided by the hardware device as results of the query operator.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1 is an illustration of a GroupBy operation;

FIG. 2 is an illustration of a Join operation;

FIG. 3 is an illustration of a GroupBy operation using one level of partitioning;

FIG. 4 is an illustration of a Join operation using one level of partitioning;

FIG. 5 is an illustration of an example environment for accelerating one or more query operators in a hardware device;

FIG. 6 is an illustration of an example hardware device for accelerating one or more query operators;

FIG. 7 is an illustration of an example sequence of operations of a hardware device for performing a GroupBy or part of a Join operation;

FIG. 8 is an illustration of an implementation of an exemplary method for executing one or more query operators on a hardware device;

FIG. 9 is an illustration of an implementation of an exemplary method for executing a query operator on a hardware device; and

FIG. 10 is an illustration of an exemplary computing environment in which example embodiments and aspects may be implemented.

### DETAILED DESCRIPTION

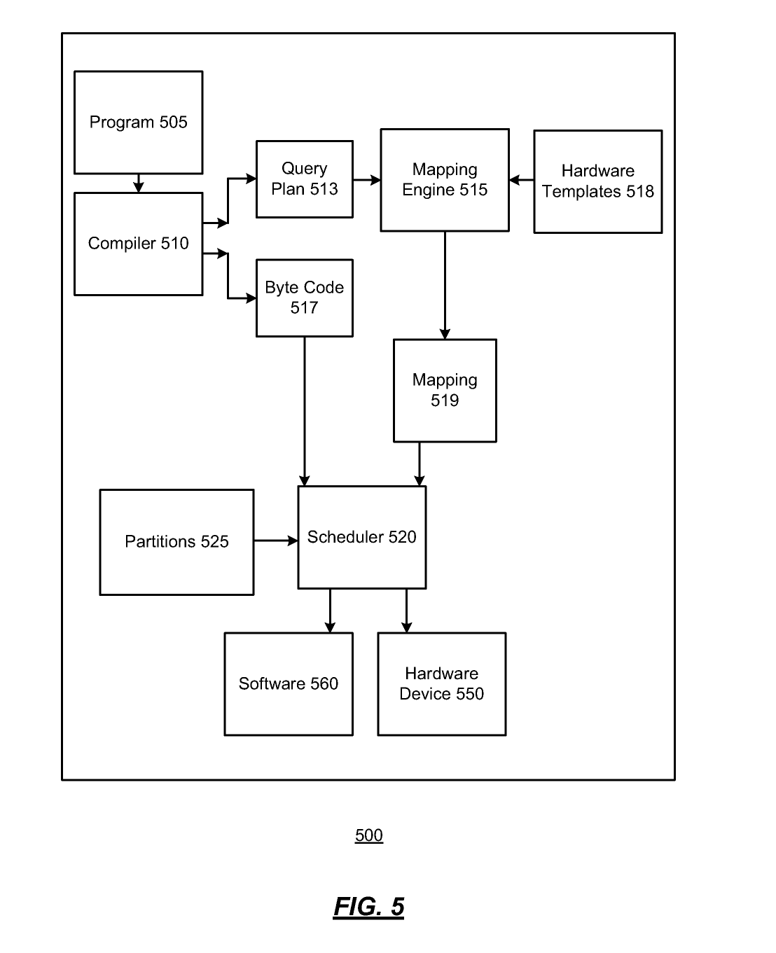

As will be described further with respect to FIG. 5, a hardware accelerator is provided that efficiently accelerates query operators for large input datasets. The hardware accelerator may be used with a variety of query based programming languages such as LINQ and SQL. Other programming languages may also be supported.

LINQ is a .NET framework component for manipulating sets or collections of elements. LINQ has seven primary operators, and as described further below, also allows users to create their own custom lambda operators or functions. The lambda operators may be combined with one or more of the primary operators. The seven primary LINQ operators are Where, Select, SelectMany, Aggregate, OrderBy, GroupBy, and Join.

The Where operator applies a Boolean filter or expression to an input collection and returns elements of the collection that evaluate to true. Multiple Where operations may be combined to create more complex expressions. In addition, a custom lambda operator may be used as the Boolean filter for the Where operator.

The Select operator performs a projection onto an input collection, resulting in a new collection. The Select operator includes an expression that controls what the new collection may include. The expression may include custom lambda operators.

The SelectMany operator generates a collection for each element in the input (by applying a function), then concatenates the resulting collections. The expression may include custom lambda operators.

The Aggregate operator takes as an input two items of a collection, and outputs a new data collection that is a combination of the two input items. The Aggregate operator includes an expression that controls how the input data collections are combined. Similar to the Select operator, the expression may include custom lambda operators.

The OrderBy operator takes as input an input data collection and sorts the elements of the input data collection according to a key generated for each element. A default expression or a custom lambda operator may be used to generate the keys.

The GroupBy operator takes as an input an input data collection and creates multiple partitions of the input collection according to a key generated for each element. Similar to the OrderBy operator, the keys may be generated using either a default expression or a custom lambda operator.

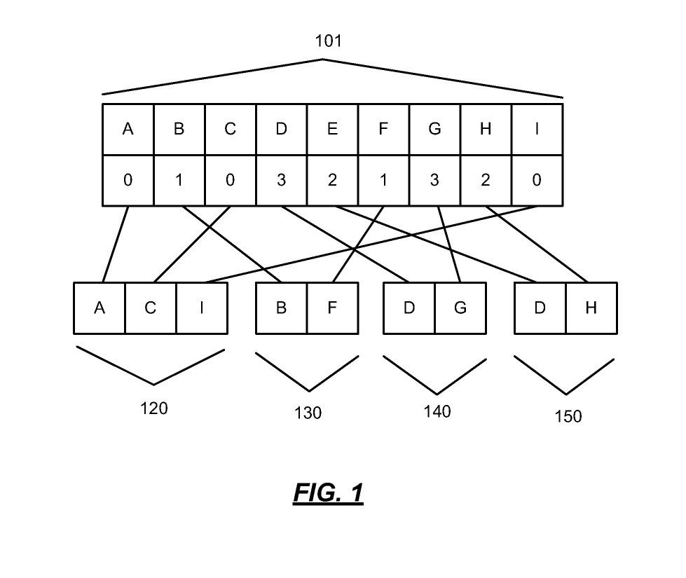

The Join operator takes as an input two input collections and performs an inner join on the input collections. Two lambda operators are used to generate keys for each element of the two input data collections. If the keys for two elements match, a third lambda operator is used to generate an element from the two matching elements. The GroupBy and Join operators are described in more detail with respect to FIGS. 1-4.

FIG. 1 is an illustration of the GroupBy operator. The GroupBy operator may take as an input an input collection of elements, and may compute a key for each element. The operator may sort each element into groups based on the computed keys. As illustrated in FIG. 1, there is an input collection of elements 101. The collection of elements 101 includes individual elements labeled A-I. Each element is shown above its corresponding key.

Based on the key corresponding to each element, the elements 101 have been sorted into one of groups 120, 130, 140, and 150. The group 120 includes the elements with a key of zero. The group 130 includes the elements with a key of one. The group 140 includes the elements with a key of three. The group 150 includes the elements with a key of two.

GroupBy operators are typically implemented in software using a hash table. Each key-element pair of the input collection is inserted by key into the hash table. On a new insertion, an array of contiguous memory is dynamically allocated and pointed to by the hash table entry; the value is then added to the array. On subsequent insertions, elements are appended to the existing array. The array is grown if necessary using dynamic re-allocation. After iterating over all key-element pairs, each array corresponds to a group of elements indexed by its key.

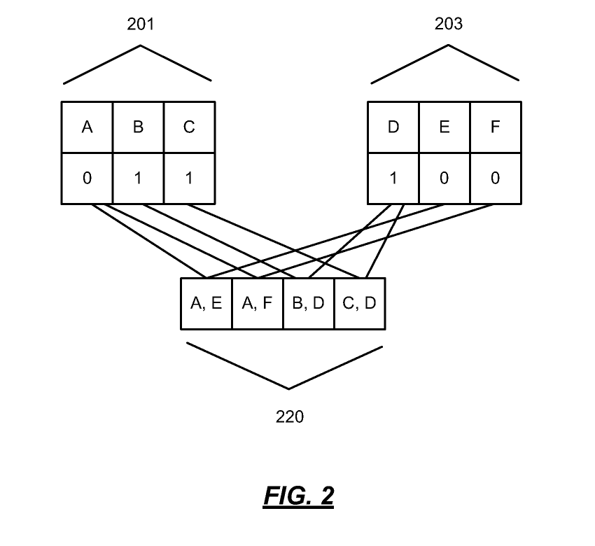

FIG. 2 is an illustration of a Join operator. The Join operator may take as an input two input collections of elements, and may compute a key for each element of both collections. The operator may identify elements with matching keys between the two collections, and may produce an output that is a function of the values based on matching keys. As illustrated in FIG. 2, there are two input collections 201 and 203. The input collection 201 includes the elements A, B, and C, and the input collection 203 includes the elements D, E, and F. Each element is similarly shown above its corresponding key.

Based on the keys corresponding to each element, the elements have been joined into a single group 220. The elements A and E, and A and F have been joined because they all have a key of zero. The elements B and D, and C and D have been joined because they all have a key of one.

Typical methods for implementing join operators include what is known as a hash join. In the hash join, each element of the first collection may be inserted into a hash table similarly as described above for the GroupBy operation. Afterwards, each element of the second collection may be used to probe the hash table, and any matches may result in computing the user-defined join function and appending the matches to a new output collection.

The GroupBy and Join operators described above may be difficult to implement efficiently in hardware and software. For hardware, the difficulty may be due to large datasets and input collects that may not fit into on-chip caches or DRAM. For software, current software implementation of hash tables may be inefficient. To mitigate these effects, software based approaches may use partitioning. In partitioning, the input collections are processed multiple times and separated into disjoint sub-partitions that have non-overlapping keys. Partitioning naturally subdivides the original collection into smaller chunks that are easier to manage individually.

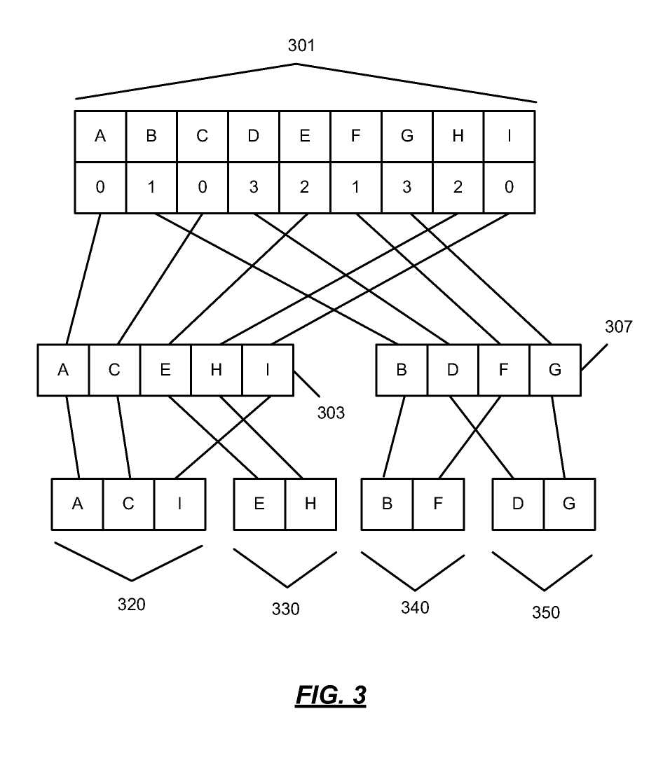

For example, FIG. 3 is an illustration of a GroupBy operation using one level of partitioning. A group of elements 301 has been partitioned into two smaller groups 303 and 307 using a partitioning key based on the original key of each element modulo two. Thus, elements with keys of zero or two have been placed in the group 303 and elements with keys of one or three have been placed in the group 307. The groups 303 and 307 are separately processed by the GroupBy operator, resulting in the output of the groups 320, 330, 340, and 350.

As can be seen with the groups 303 and 307, with partitioning there are two smaller GroupBy operations to be performed rather than just one. However, each GroupBy operation uses two unique keys, rather than four. By reducing the number of keys in each GroupBy operation using partitioning, locality can be preserved in a processor memory hierarchy resulting in improved memory performance.

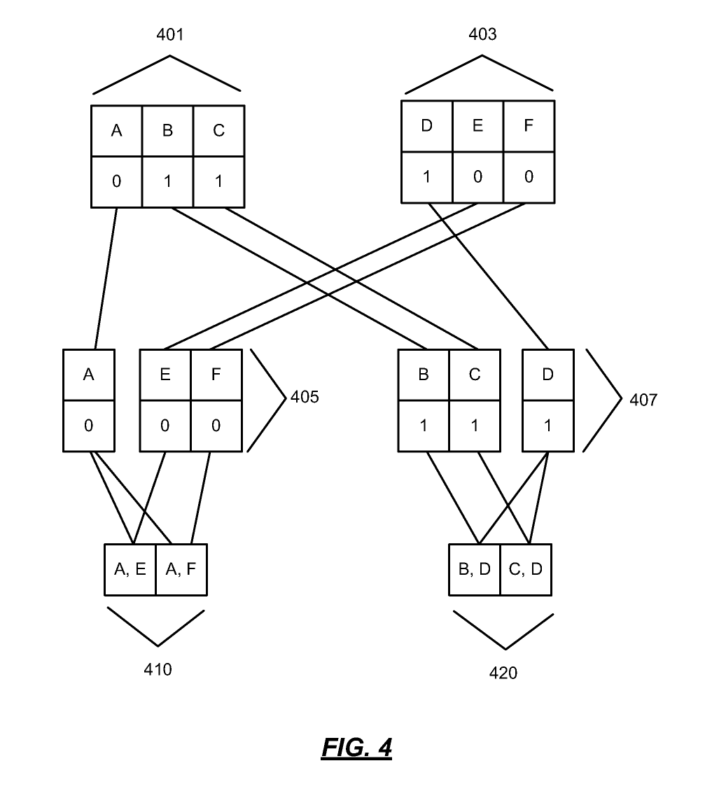

FIG. 4 is an illustration of a Join operation using one level of partitioning. Two groups of elements 401 and 403 have been partitioned into two smaller groups 405 and 407 similarly as done for the GroupBy operation in FIG. 3. Because all of the elements in the groups 405 and 407 share the same key, hash joins are performed, resulting in groups 410 and 420 with reduced thrashing in a processor cache hierarchy. In addition, the groups 405 and 407 may be joined using smaller hash joins which may be more easily fit into smaller memories or caches.

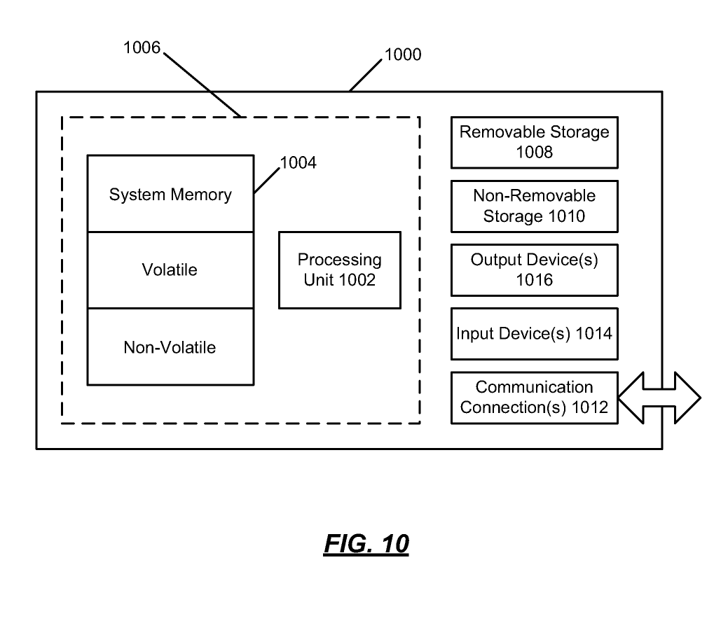

FIG. 5 is an illustration of an example environment 500 for accelerating one or more query operators in a hardware device. The environment 500 may include a program 505, a compiler 510, a mapping engine 515, and a scheduler 520. The environment 500 may further include a hardware device 550 and software 560. Some or all of the components of the environment 500 may be implemented by a general purpose computing device such as the computing device 1000 illustrated with respect to FIG. 10.

The program 505 may be a computer program written using one or more programming languages. The programming languages may include C, C#, Java, C++, etc. In addition, the program 505 may further include one or more query operators. The query operators may be written in a language such as LINQ or SQL. Other languages may be used.

The compiler 510 may receive the program 505 and may generate a query plan 513 from the query operators or LINQ code found in the program 505. The query plan 513 may comprise a graph with one or more computational nodes representing each operator, and one or more communication edges between the computational nodes. The communication edges may represent the flow of data between the computational nodes as well as the order in which the operators associated with the computational nodes may be performed. Any method, technique for generating a query plan 513 from one or more query operators may be used.

The compiler 510 may further generate byte code 517. The byte code 517 may be generated from the portion of the program 505 that is not a query expression (i.e., not LINQ code). The byte code 517 may be generated by the compiler 510 using any known method or technique for compiling code.

The mapping engine 515 may receive the query plan 513 and may generate a mapping 519 of one or more computational nodes (i.e., operators) of the query plan 513 to one or more configurations of the hardware templates 518. Each configuration of the hardware template 518 may correspond to a LINQ operator and/or a custom lambda function. The hardware templates 518 may comprise settings and/or configurations for the hardware device 550 to implement the associated query operator and/or lambda function.

In some implementations, the mapping engine 515 may generate the mapping 519 by replacing each computational node in the query plan 513 with a corresponding hardware template 518. Alternatively, a user or administrator may annotate the query plan 513 to indicate which computational node(s) may be accelerated by the hardware device 550. The mapping engine 515 may replace the indicated nodes with their corresponding hardware templates 518.

The scheduler 520 may receive the byte code 517 and the mapping 519 and may schedule and control the execution of portions of the byte code 517 and the mapping 519 on one or more of the software 560 and/or the hardware device 550. The software 560 may represent a conventional environment for executing the byte code 517 and/or portions of the mapping 519 that are not to be accelerated by the hardware device 550. The software 560 may be executed by the same or different computing device that is executing the scheduler 520, for example.

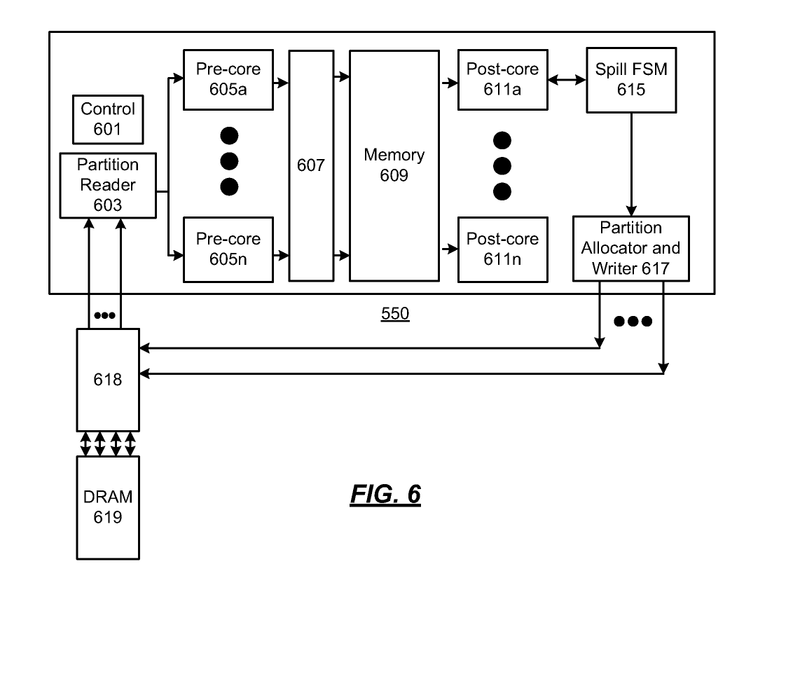

The hardware device 550 may comprise a specialized hardware device for executing one or more LINQ or SQL operators. The hardware device 550 may be configured by the scheduler 520 using the hardware templates 518 that are part of the mapping 519. In some implementations, the hardware device 550 may be implemented using a Field Programmable Gate Array (FPGA). Alternatively, the hardware device 550 may be an Application Specific Integrated Circuit (ASIC). Other types of hardware devices 550 may be used. An example of a hardware device 550 is described is greater detail with respect to FIG. 6.

The scheduler 520 may provide data from one or more partitions 525 to the hardware device 550. The scheduler 520 may determine the input datasets for the hardware device 550 when executing hardware templates 518 corresponding to the computational nodes based on the computational edges of the query plan 513. The data from one or more of the partitions 525 may be provided to the hardware device 550 as a data stream. Other formats may be used.

FIG. 6 is an illustration of an example hardware device 550 for accelerating one or more query operators. The hardware device 550 includes components including, but not limited to, a control 601, a partition reader 603, pre-cores 605a-605n, a crossbar switch or data network 607, a memory 609, post-cores 611a-611n, a Spill FSM 615, and a partition allocator and writer 617. More or fewer components may be supported by the hardware device 550. The hardware device 550 may allow for a single hardware template 518 to be configured for all the query operators.

The control 601 may switch the hardware device 550 from operating between what are referred to herein as a partition mode, a hash table mode, a filter and map mode, and an aggregate mode based on the particular hardware template 518 received from the scheduler 620. During the partition mode, the partition reader 603 may receive partition data (from DRAM 619 via a switch 618) and the partition allocator and writer 617 may allocate and redistribute the received partition data to multiple new partitions in the memory 609. As described further below, the memory 609 may be organized into a plurality of queues with each queue corresponding to one of the multiple new partitions.

The control 601 may control which of the one or more pre-cores 605a-605n and post-cores 611a-611n are applied to the received partition data. Each of the pre-cores 605a-605n may be programmed to support one or more user-defined lambda functions. The pre-cores 605a-605n may also be programmed to perform one or more filter functions (for Where operators), and one or more projection or transformation functions (for Select operators). The pre-cores 605a-605n may apply functions or operations to the data before it is stored in one or more of the partitions of the memory 609.

In addition, the pre-cores 605a-605n may generate the keys for each data element of the received partition data that is used to partition the data. As described above, for both the GroupBy and Join operators, the data may be partitioned based one or more generated keys. Other functions or operators may be supported by the pre-cores 605a-605n.

The post-cores 611a-611n may apply functions and/or operators to the final partition data stored in the memory 609. Similar to the pre-cores 605a-605n, the post-cores 611a-611n may be user programmed to support a variety of functions and/or operators. Example operators that may be implemented using the post-cores 611a-611n include the Aggregate and Join operators. Other operators may be supported.

The hardware device 550, during the partition mode, may subdivide the received partition data from the scheduler 520 into a plurality of sub-partitions. Each sub-partition may be stored in a queue of the memory 609. Each element of the partition data may be divided into the sub-partitions based on a key that is computed for the element based on a function stored in one or more of the pre-cores 605a-605n. In an implementation, at a first stage, the hardware device 550 may divide the received partition data into 64 sub-partitions. After the partition data has been received, during subsequent stages the hardware device 550 may continue to subdivide each of the 64 sub-partitions into another 64 sub-partitions (resulting in 4096 sub-partitions) until a desired or predetermined number of partitioning steps are performed.

In some implementations, each data element may be directed to its associated queue or partition by the crossbar switch 607. When a data element is received from one of the pre-cores 605a-605n, the crossbar switch 607 may read the key associated with data element, and may direct the data element to the queue or partition of the memory 609 that corresponds to the key. In implementations where the memory 609 is large, a scalable network may be used to direct data elements to the corresponding queues or partitions of the memory 609.

Depending on the LINQ or SQL operator that is being accelerated by the hardware device 550, after the partition data has been sub-partitioned into the desired or predetermined number of sub-partitions, the control 601 may enter the hardware device 550 into the hash table mode. During the hash table mode, the partition reader 603 may reconfigure the queues of the memory 609 to operate as a hash table. During hash table mode, each of the data stored in each queue belongs to the same group in the hash table. As shown in FIGS. 3 and 4, hash tables may be used in the final stage of the partitioned GroupBy and Join operations.

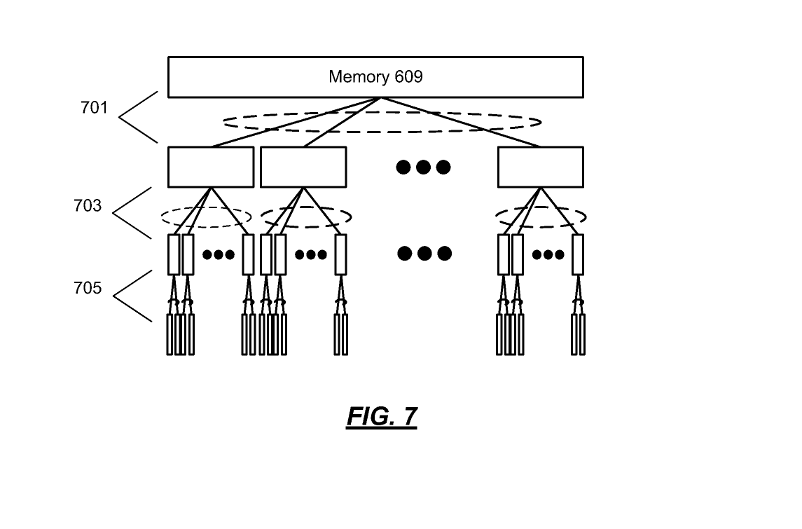

For example, FIG. 7 is an illustration of an example sequence of operations of a hardware device (such as the hardware device 550) for performing a GroupBy or part of a Join operation. In the example shown, each of the ovals represents a single invocation of the hardware device 550 operating in one of the partition or hash table modes. At 701, the hardware device 550 may enter the partition mode and may partition the data of the memory 609 into a plurality of sub-partitions or queues. At 703, the hardware device 550 may continue in the partition mode and may further partition the data in each of the sub-partitions or queues created at 701 into smaller sub-partitions or queues. At 705, the hardware device 550 may then enter the hash table mode where the data in each of the sub-partitions or queues is associated with the same group in a hash table.

The partition allocator and writer 617 may dynamically allocate arrays and partitions of the memory 609. Because the partition sizes and locations of data that is received by the hardware device 550 are unknown, the partition allocator and writer 617 may manage memory block allocation of the memory 609.

The partition allocator and writer 617 may manage the memory 609 using a particular data structure that may be read by the partition reader 603. In some implementations, the data structure may comprise three portions: a free list, partition metadata, and data arrays. The free list may comprise a list of free fixed size arrays. Each array may be the size of a memory page. The partition metadata may comprise a list of the used partitions, and each partition may include four fields. The data arrays may be the arrays that are used for storage.

The four fields of each partition may include a key field, a next field, a root field, and size field. The key field may be an identifier of the partition. The next field may be a pointer to another partition and may allow for the linking of partitions. The root field may be a pointer to the data array that is the beginning of the partition. Each data array allocated to a partition may have a pointer to the next data array for the partition. The size field may indicate the size of the partition. Other types of data structures may be used.

The Spill Finite-State Machine (FSM) 615 may handle queue overflows and/or conflicts for the hardware device 550 when operating in hash table mode. In some implementations, the partition allocator and writer 617 may place any conflicting data items in a single queue of the memory 609 that is reserved for conflicting data. After a LINQ or SQL operation has been processed by the hardware device 550 with respect to the data in the other queues, the Spill FSM 615 may stream the conflicting data elements back to the pre-cores 605a-605n and/or the post-cores 611a-611n to complete the particular LINQ or SQL operation.

In the filter and map mode, the hardware device 550 may be configured using the hardware templates 518 to reconfigure the queues of the memory 609 to function as a single logical queue. The pre-cores 605a-605n may then compute the user-defined lambda functions on received data and store the results in the logical queue. Examples of operators that may use the filter and map mode may include Select, SelectMany, and Where. For the Select and SelectMany operators, the post cores 605a-605n may compute the lambda functions that map the input data to outputs. For the Where operator, the pre-cores 605a-605n may compute the lambda functions that map the input data to one or more predicates.

In the aggregate mode, the hardware device 550 may operate similarly as in the filter and map mode, except rather than store data in the single logical queue, a register of the hardware device 550 may be used to store data. The accumulation function associate with the aggregate operator may then be performed on the data by one or more of the post-cores 611a-611n.

The performance of each of the query operators Where, Select, Aggregate, by the hardware device 550 is now described. With respect to Where, the operator may be performed by the hardware device 550 in a single pass. The Where operator is typically performed by applying a filter (such as a user defined lambda function) to an input collection and generating an output collect based on the application of the filter. Accordingly, the hardware device 550 may operate in the filter and map mode and may use the pre-cores 605a-605n to apply the filter to the input data. The resulting data may then be directed to a single logical queue of the memory 609 that is created by chaining the various queues of the memory 609 together. A counter may be used by the hardware device 550 to direct the data to the correct queue. In general, the queues of the memory 609 in the hardware device 550 are used as a circular FIFO with memory backing. This may allow the hardware device 550 to provide large sequential burst for reads and writes. The results of the Where operator may be written in burst of pages and linked together with the last entry in the FIFO used to store the pointer to the next page of the collection in the memory 609.

With regards to the Select operator, this operator may also be performed by the hardware device 550 in the filter and map mode. For the Select operator, a map is performed on the input data collection and an output data collection is generated based on the map. The pre-cores 605a-605n may apply the map to the input data and store the resulting output data collection in the logical queue or circular FIFO similarly as described above for the Where operator.

With regards to the Aggregate operator, this operator may be performed by the hardware device 550 in a single pass in the aggregate mode. For the Aggregate operator, a fold is performed on the input data collection and an intermediate or a final output data collection is generated and may be stored in the queues of the memory 609. The post-cores 611a-611n may then apply one or more lambda functions or functions such as Count, Sum, Min, and Max to the data stored in the queues. Each queue may be viewed as a register to hold independent aggregate results. In some implementations, the functions may be applied to the stored data in parallel.

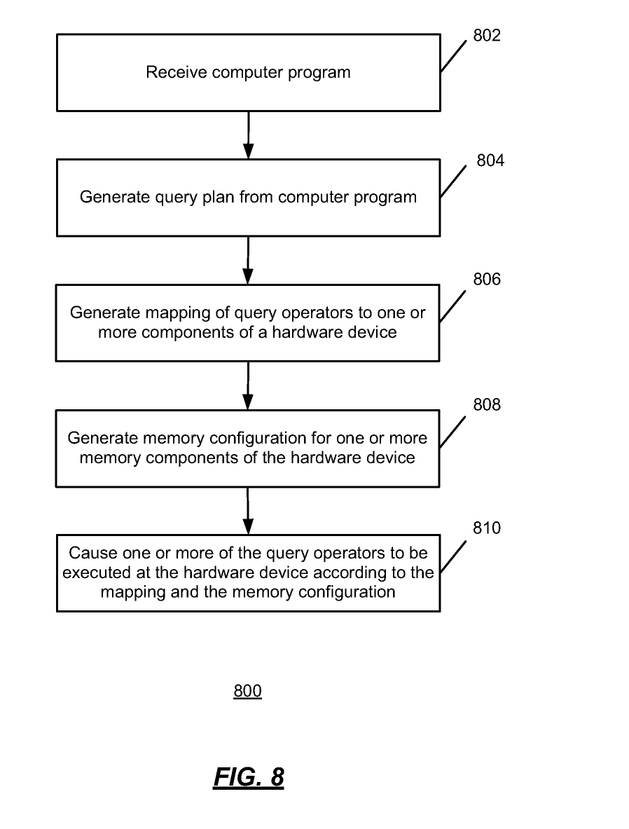

FIG. 8 is an illustration of an implementation of an exemplary method 800 for executing one or more query operators on a hardware device 550. The method 800 may be implemented using the environment 500, for example.

A computer program is received at 802. The computer program 505 may be received by the compiler 510 of the environment 500. The computer program 505 may include one or more query operators. The query operators may be written using a query language such as LINQ or SQL. Other languages may be used.

A query plan is generated from the computer program at 804. The query plan 513 may be generated by the compiler 510 and may include a plurality of computational nodes and communication edges. Each computational node may correspond to a query operator of the computer program 505. The communication edges between nodes may represent the flow of data from one query operator to another, as well as an order in which the query operators may be executed.

A mapping of query operators to one or more components of a hardware device is generated at 806. The mapping may be generated by the mapping engine 515 using hardware templates 518 corresponding to each of the query operators. The hardware templates 518 may comprise configuration parameters for the hardware device 550 to perform the associated query operators. The hardware templates 518 may be specific to the hardware device 550 used to perform the query operator acceleration.

A memory configuration for one or more memory components of the hardware device is generated at 808. The memory configuration may be generated by the mapping engine 515 using the hardware templates associated with each query operator of the plurality of query operators.

One or more of the query operators are caused to be executed at the hardware device at 810. The one or more of the query operators are caused to be executed at the hardware device 550 according to the mapping 519 and the memory configuration by the scheduler 520. The scheduler 520 may cause a query operator to be executed by loading the hardware template 518 corresponding to the query operator in to the hardware device 550. In addition, the scheduler 520 may stream data used by the query operator from the partitions 525 to the hardware device 550. The data used by the query operator may be determined by the scheduler 520 based on the computational edges of the mapping 519 and/or query plan 513.

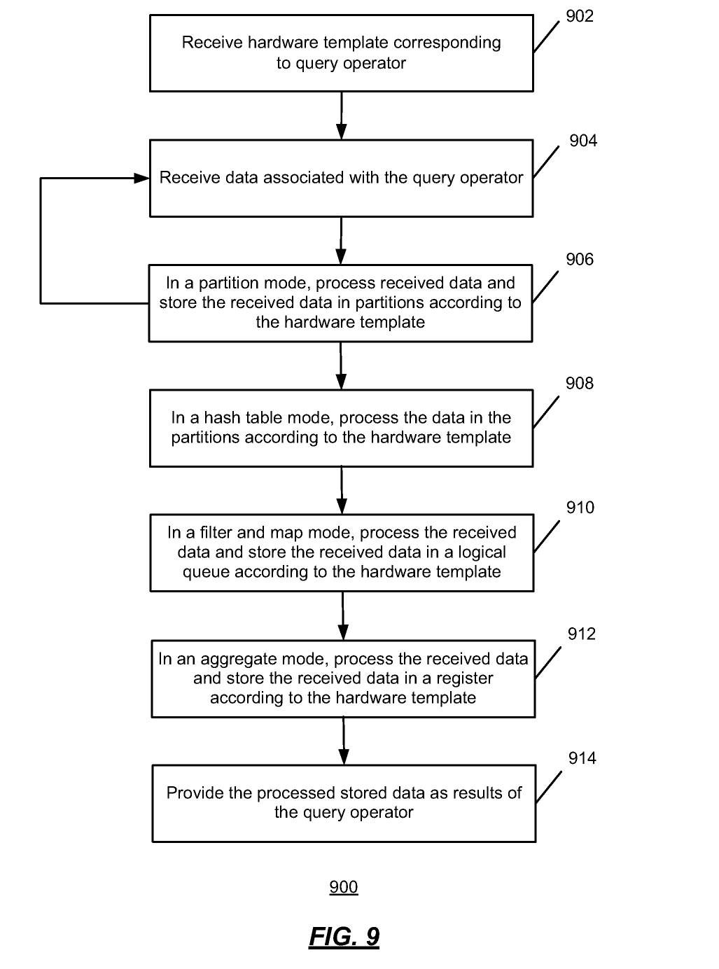

FIG. 9 is an illustration of an implementation of an exemplary method 900 for executing a query operator on a hardware device 550. The method 900 may be implemented using the hardware device 550.

A hardware template corresponding to a query operator is received at 902. The hardware template 518 may be received by the hardware device 550 from a scheduler 520. The hardware device 550 may be hardware accelerator and may be implemented using one or more of a FPGA or an ASIC. The query operator may be a LINQ or SQL operator and may include operators such as Join, GroupBy, Where, Select, and Aggregate. Other types of query operators may be supported. The hardware device 550 may be configured to implement one or more operators at run-time using a single hardware template 518.

Data associated with the query operator is received at 904. The data may be received from the scheduler 520 by the partition reader 603 of the hardware device 550. The data may be streamed from one or more of the partitions 525. Alternatively or additionally, some or all of the data may be received from a previous query operator and may be already stored within the memory 609 of the hardware device 550.

In a partition mode, the received data is processed and stored in a plurality of partitions according to the hardware template at 906. The received data may be stored in a plurality of partitions of the memory 609 by the partition allocator and writer 617 of the hardware device 550. Each partition may be implemented as a queue within the memory 609. During the partition mode, the data in each queue may be continuously sub-partitioned until a desired or predetermined number of partitions are created. For example, in some implementations the data may be partitioned in to 4096 partitions. The number and/or size of each partition may be based on the size of the memory 609. The received data may be partitioned according to one or more keys that are calculated by one or more of the pre-cores 605a-605n, for example. Example operators that may be performed in the partition mode include GroupBy and Join. Depending on the implementation, the method 900 may either continue to 908 and enter the hash table mode, or may return to 904 where additional data may be received or the data may be further sub-partitioned in the partition mode.

In addition, one or more functions may be applied to the received data by one or more of the pre-cores 605a-605n based on the particular query operator that is being implemented. The one or more functions may be user-defined lambda functions. The one or more functions may be loaded into one or more of the pre-cores 605a-605n by the hardware device 550 based on the hardware template 518 associated with the query operator.

In a hash table mode, the stored data in the plurality of partitions is processed according to the hardware template at 908. In the hash table mode, the memory 609 of the hardware device 550 may function as a hash table with the data in each queue and/or partition corresponding to a different group. The stored data in the plurality of partitions may be processed by one or more of the post-cores 611a-611n of the hardware device 550. The post-cores 611a-611n may process the data based on the particular query operator that is being implemented. In addition, the post-cores 611a-611n may apply one or more user-defined lambda functions. Example operators that may be performed in the hash table mode include GroupBy and Join.

In some implementations, during hash table mode, any queue or partition overflows, or situations where two queues or partitions map to the same key, may be handled by the Spill FSM 615. In particular, the Spill FSM 615 may store the overflowing or conflicting data items in a queue or partition of the memory 609. When the stored data is processed by the post-cores 611a-611n, the Spill FSM 615 may ensure that the overflowing or conflicting data is also processed. The process stored data is provided as results of the query operator at 914. The data may be provided by the hardware device 550 to the scheduler 520. Alternatively or additionally, the data may be stored in the memory 609 for use by a subsequent query operator.

FIG. 10 shows an exemplary computing environment in which example embodiments and aspects may be implemented. The computing system environment is only one example of a suitable computing environment and is not intended to suggest any limitation as to the scope of use or functionality.

Numerous other general purpose or special purpose computing system environments or configurations may be used. Examples of well known computing systems, environments, and/or configurations that may be suitable for use include, but are not limited to, personal computers (PCs), server computers, handheld or laptop devices, multiprocessor systems, microprocessor-based systems, network PCs, minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 10, an exemplary system for implementing aspects described herein includes a computing device, such as computing device 1000. Computing device 1000 depicts the components of a basic computer system providing the execution platform for certain software-based functionality in accordance with various embodiments. Computing device 1000 can be an environment upon which a client side library, cluster wide service, and/or distributed execution engine (or their components) from various embodiments is instantiated. Computing device 1000 can include, for example, a desktop computer system, laptop computer system, or server computer system. Similarly, computing device 1000 can be implemented as a handheld device (e.g., cellphone, etc.). Computing device 1000 typically includes at least some form of computer readable media. Computer readable media can be a number of different types of available media that can be accessed by computing device 1000 and can include, but is not limited to, computer storage media.

In its most basic configuration, computing device 1000 typically includes at least one processing unit 1002 and memory 1004. Depending on the exact configuration and type of computing device, memory 1004 may be volatile (such as random access memory (RAM)), non-volatile (such as read-only memory (ROM), flash memory, etc.), or some combination of the two. This most basic configuration is illustrated in FIG. 10 by dashed line 1006.

Computing device 1000 may have additional features/functionality. For example, computing device 1000 may include additional storage (removable and/or non-removable) including, but not limited to, magnetic or optical disks or tape. Such additional storage is illustrated in FIG. 10 by removable storage 1008 and non-removable storage 1010.

Computing device 1000 typically includes a variety of computer readable media. Computer readable media can be any available media that can be accessed by device 1000 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 1004, removable storage 1008, and non-removable storage 1010 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 1000. Any such computer storage media may be part of computing device 1000.

Computing device 1000 may contain communication connection(s) 1012 that allow the device to communicate with other devices. Computing device 1000 may also have input device(s) 1014 such as a keyboard, mouse, pen, voice input device, touch input device, etc. Output device(s) 1016 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method comprising:
receiving a query plan at a computing device, wherein the query plan comprises a plurality of computational nodes and each computational node corresponds to a query operator;
generating a mapping of the query operators corresponding to one or more of the computational nodes to one or more components of a hardware device; and
causing one or more of the query operators to be executed at the hardware device according to the mapping by the computing device.

2. The method of claim 1, wherein the hardware device comprises one or more of a Field Programmable Gate Array or an Application Specific Integrated Circuit.

3. The method of claim 1, wherein the query operators are one or more of LINQ operators or SQL operators.

4. The method of claim 1, wherein the query operators are one or more of a Join operator, a Select operator, a SelectMany operator, a Where operator, an Aggregate operator, a GroupBy operator, or a GroupByAggregate operator.

5. The method of claim 1, wherein the one or more query operators includes one or more lambda functions, and causing one or more of the query operators to be executed at the hardware device comprises causing the one or more lambda functions to be executed in a pre-core or post-core of the hardware device.

6. The method of claim 1, wherein at least one of the one or more query operators identifies a data partition, and causing the at least one of the one or more query operators to be executed at the hardware device according to the mapping comprises streaming data associated with the data partition to the hardware device.

7. The method of claim 6, wherein the hardware device receives the data associated with the data partition and stores the data in a plurality of sub-partitions.

8. The method of claim 7, wherein each sub-partition is associated with a queue of a plurality of queues.

9. The method of claim 8, wherein each queue is associated with a group of a hash table.

10. A method comprising:
receiving a hardware template corresponding to a query operator at a hardware device;
receiving data associated with the query operator at the hardware device;
in a partition mode, processing the received data and storing the received data in a plurality of partitions according to the hardware template by the hardware device;
in a hash table mode, processing the stored data in the plurality of partitions according to the hardware template by the hardware device; and
providing the processed stored data by the hardware device as results of the query operator.

11. The method of claim 10, wherein processing the received data and storing the received data in a plurality of partitions according to the hardware template comprises:
re-partitioning the stored data in the plurality of partitions into a plurality of sub-partitions according to the hardware template; and
processing the stored data in the plurality of sub-partitions according to the hardware template.

12. The method of claim 10, wherein the query operator is one or more of a LINQ operator or an SQL operator.

13. The method of claim 10, wherein the query operator is one or more of a Join operator, a Select operator, a SelectMany operator, a Where operator, an Aggregate operator, a GroupBy operator, or a GroupByAggregate operator.

14. The method of claim 10, wherein processing the received data and storing the received data in a plurality of partitions according to the hardware template comprises:
storing at least one function in a pre-core of the hardware device according to the hardware template; and
processing the received data by the pre-core using the at least one function.

15. The method of claim 14, wherein the function comprises one or more of a lambda function or a key generating function.

16. The method of claim 10, further comprising:
in a filter and map mode, processing the received data and storing the received data in a logical queue according to the hardware template by the hardware device; and
in an aggregate mode, processing the received data and storing the received data in a register according to the hardware template by the hardware device.

17. The method of claim 16, further comprising, in the aggregate mode, processing the stored data in the register by one or more post-cores of the hardware device.

18. A system comprising:
a hardware device; and
a software module adapted to:
receive a computer program, wherein the computer program comprises a plurality of query operators;
generate a query plan from the computer program, wherein the query plan comprises a plurality of computational nodes and each computational node corresponds to a query operator of the plurality of query operators;
generate a mapping of the query operators corresponding to one or more of the computational nodes to one or more components of a hardware device using hardware templates associated with each query operator of the plurality of query operators;
generate a memory configuration for one or more memory components of the hardware device using the hardware templates associated with each query operator of the plurality of query operators; and
configure the hardware device to execute one or more of the query operators according to the mapping and the memory configuration.

19. The system of claim 18, wherein the query operators are one or more of LINQ operators or SQL operators.

20. The system of claim 18, wherein the query operators are one or more of a Join operator, a Select operator, a SelectMany operator, a Where operator, an Aggregate operator, a GroupBy operator, or a GroupByAggregate operator.
